(19) United States
(12) Patent Application Publication
(10) Pub. No.: US 2009/0266831 A1
(43) Pub. Date: Oct. 29, 2009

(54) APPARATUS CONFIGURED TO HOLD A BOTTLE STOPPER AND METHOD FOR MANUFACTURING SAME

(76) Inventor: Marjorie A. McConville, Orland Park, IL (US)

Correspondence Address: LAW OFFICE OF STEVEN R. OLSEN, PLLC, P.O. BOX 2092, INVERNESS, FL, 34451-2092, US

(21) Appl. No.: 12/429,175

(22) Filed: Apr. 23, 2009

Related U.S. Application Data
(60) Provisional application No. 61/125,716, filed on Apr. 28, 2008.

(51) Int. Cl. B65D 55/16; B23P 19/04

(52) U.S. Cl. 220/744; 220/379; 29/428; 29/433

(57) ABSTRACT

An embodiment of the invention provides an apparatus that is configured to secure a stopper to a beverage container or other container. The apparatus could be used, for instance, after a person has removed a cork or other stopper from the mouth of a bottle. Such an apparatus reduces the chance that the stopper will be lost. A portion of the apparatus may also be configured to absorb drips that could result from pouring a beverage or other liquid from the container. The apparatus may also display a message and/or provide other decorative features. Other embodiments of the invention provide a method for manufacturing the apparatus.

### CROSS-REFERENCE TO RELATED APPLICATIONS

This application claims the benefit of U.S. Provisional Application No. 61/125,716, filed on Apr. 28, 2008.

### BACKGROUND OF THE INVENTION

1. Field of the Invention

The invention relates generally to a bottle or other container, and more particularly, but without limitation, to an apparatus configured to secure a cork or other stopper, and a method for manufacturing the apparatus.

2. Description of the Related Art

Some containers, and especially wine bottles or other beverage containers, utilize a stopper made of cork, plastic, or other material to seal the mouth of the container. It may be advantageous to retain such a stopper after removal from the mouth of the container. For instance, persons may wish to smell or otherwise inspect a cork stopper that has been removed from a wine bottle, for example. Persons may also wish to save the cork or other stopper as a memento.

If a person merely sets the stopper aside, the stopper may become lost. In addition, if the stopper is temporarily stored on a tablecloth, trace amounts of the wine or other beverage remaining on the stopper could stain the tablecloth. Some persons might retain a stopper by repeatedly replacing it in the mouth of a wine bottle. But such a method carries the risk that loose cork particles from the stopper will contaminate the wine that remains in the bottle.

For at least the foregoing reasons, an apparatus for securing a cork or other stopper after a person removes the stopper from the mouth of a container is needed.

### BRIEF SUMMARY OF THE INVENTION

Embodiments of the invention seek to overcome one or more of the shortcomings described above. An embodiment of the invention provides an apparatus that is configured to secure a stopper to a beverage container or other container. The apparatus could be used, for instance, after a person has removed a cork or other stopper from the mouth of a bottle. Such an apparatus reduces the chance that the stopper will be lost. The apparatus may also be configured with an absorbent collar to absorb drips that could result from pouring a beverage or other liquid from the container. The apparatus may also display a message and/or provide other decorative features. Other embodiments of the invention provide a method for manufacturing the apparatus.

### BRIEF DESCRIPTION OF THE DRAWINGS

The invention will be more fully understood from the detailed description below and the accompanying drawings, wherein:

FIG. 1 is a perspective view drawing of an apparatus configured to hold a bottle stopper, according to an embodiment of the invention;

FIG. 2 is a perspective view drawing of an apparatus configured to hold a bottle stopper, according to an embodiment of the invention;

FIG. 3 is a perspective view drawing of an apparatus configured to hold a bottle stopper, according to an embodiment of the invention;

FIG. 4 is a flow diagram of a manufacturing method, according to an embodiment of the invention;

FIG. 5 is a flow diagram of a manufacturing method, according to an embodiment of the invention;

FIG. 6 is a flow diagram of a manufacturing method, according to an embodiment of the invention; and

FIG. 7 is a flow diagram of a manufacturing method, according to an embodiment of the invention.

### DETAILED DESCRIPTION OF THE INVENTION

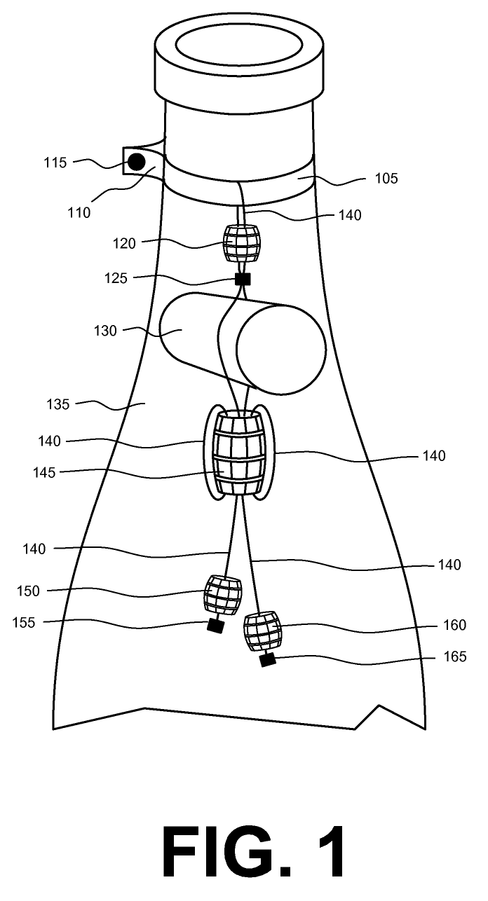

Embodiments of the invention will now be described more fully with reference to FIGS. 1 through 7, in which embodiments of the invention are shown. This invention may, however, be embodied in many different forms and should not be construed as limited to the embodiments set forth herein. In the drawings, reference designators may be duplicated for the same or similar features. The drawings are not necessarily drawn to scale; some features may be exaggerated for clarity.

FIG. 1 is a perspective view drawing of an apparatus configured to hold a bottle stopper, according to an embodiment of the invention. As illustrated therein, a collar 105 is disposed around a neck of a bottle 135. The collar 105 may be or include, for instance, an elastic band. In addition, the collar 105 may include a handle portion 110. The handle portion 110 may be used, for instance, to facilitate assembly of the collar 105 around the neck of the bottle 135. The handle portion 110 may be formed by, and include, a fastener 115. The fastener 115 may be or include, for instance, a stud, a snap, a rivet, or other fastener. In one respect, the collar 105 provides an anchor for the cord 140. In another respect, the collar 105 may be absorbent and thus configured to absorb drips that are created at the mouth of the bottle 135 when wine or other liquid in the bottle 135 is being dispensed.

The cord 140 may be or include elastic. The cord 140 may encircle a portion of the collar 105, such that two ends of the cord 140 extend from the collar 105. Both ends of the cord 140 may be threaded through a decorative bead 120. A crimp 125 on two portions of the cord 140 may secure the decorative bead 120 near the collar 105. A slip knot may be formed by twice passing both ends of the cord 140 through a retaining bead 145. When the apparatus is in use, a cork 130 may be secured between portions of the cord 140 that are disposed between the crimp 125 and the slip knot that is formed using the retaining bead 145.

A first end of the cord 140 may further pass through a decorative bead 150 and include a crimp 155 at its terminus. A second end of the cord 140 may further pass through a decorative bead 160 and include a crimp 165 at its terminus.

The crimps 125, 155, and 165 may be or include, for instance, deformable metal. The beads 120, 145, 150 and 160 may be or include, for example, metal, plastic, or other suitable material.

Variations to the embodiment illustrated in FIG. 1 are possible. For instance, the collar 105 need not include the handle portion 110 and/or the fastener 115. Moreover, in an alternative embodiment, the collar 105 need not be elastic (e.g., the collar 105 could be rigid and snap onto the bottle 135, or the collar 105 could be flexible and fasten to the bottle 135 using a buckle or other known means). Likewise, the cord 140 need not be elastic. Furthermore, any one or more of the decorative beads 120, 150, and 160 could be deleted, according to design choice. Additional decorative beads could be added to the cord 140, for instance on one or more sides of the decorative beads 120, 150, and/or 160. It also should be appreciated that a variety of shapes could be used for the decorative beads 120, 150, 60, and the retaining bead 145, and that it is not necessary for any of the foregoing beads to have the same shape. In alternative embodiments, any one or more of the crimps 125, 155 and 165 could be omitted or replaced with a knot in the cord 140. The shape of the crimps 125, 155 and 165 may also be varied, according to design preference.

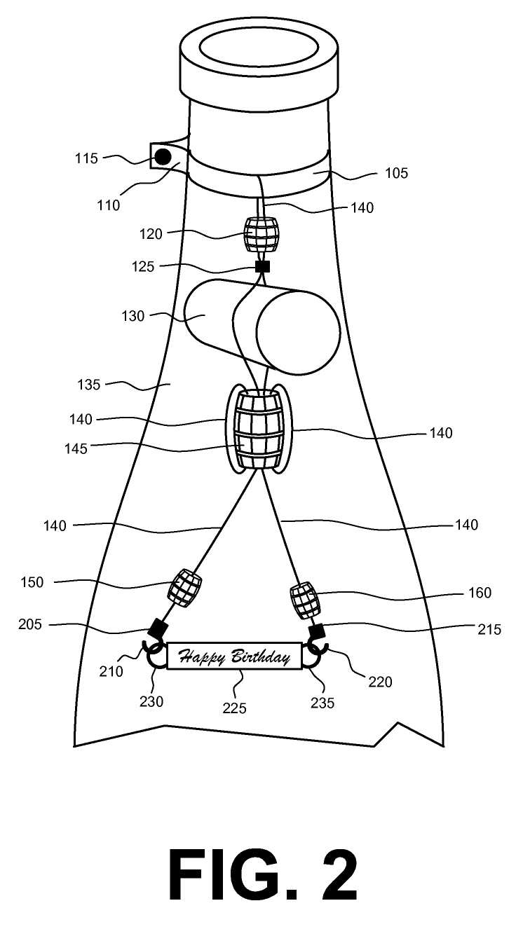

FIG. 2 is a perspective view drawing of an apparatus configured to hold a bottle stopper, according to another embodiment of the invention. For brevity, the description of common features discussed above is not repeated.

The embodiment illustrated in FIG. 2 includes crimp 205 at one terminus of the cord 140 and crimp 215 at the other terminus of the cord 140. The crimp 205 retains the decorative bead 150 on the cord 140. Likewise, the crimp 215 retains the decorative bead 160 on the cord 140. The crimp 205 includes a hook 210, and the crimp 215 includes a hook 220. A charm 225 that includes eyelets 230 and 235. Hook 210 engages with the eyelet 230; hook 220 engages with the eyelet 235. In an alternative embodiment, the hooks 210 and 220 could be flattened to more robustly secure the charm 225. The charm 225 could include, for example, a printed greeting such as “Happy Birthday”, or “Happy Anniversary.” Alternatively, the charm 225 could include a person's name, an expression of emotion, or other text. The charm 225 need not include text, however.

Alternative embodiments are possible. For instance, any of the variations discussed above with reference to FIG. 1 are also possible with respect to the embodiment illustrated in FIG. 2.

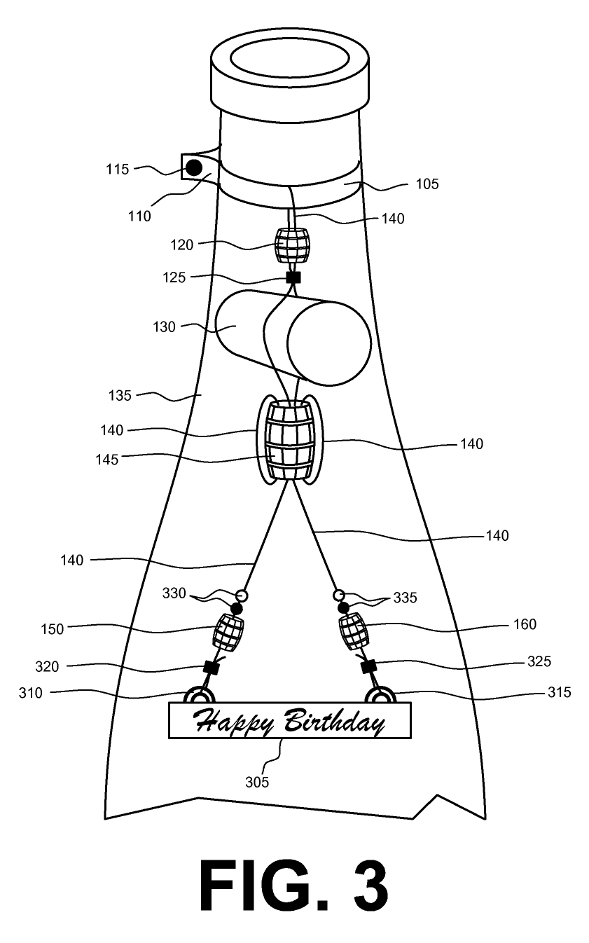

FIG. 3 is a perspective view drawing of an apparatus configured to hold a bottle stopper, according to an embodiment of the invention. For brevity, the description of common features discussed above is not repeated.

The embodiment illustrated in FIG. 3 includes a charm 305 that has eyelets 310 and 315. The charm 305 is secured to each end of the cord 140. More specifically, a first end of the cord 140 is looped through the eyelet 310 and is secured to one portion of the cord 140 by a crimp 320. A second end of the cord 140 is looped through the eyelet 315 and is secured to another portion of the cord 140 by a crimp 325. The crimp 320 also retains the decorative bead 150 on the cord 140. Similarly, the crimp 325 retains the decorative bead 160 on the cord 140. In the illustrated embodiment, two additional decorative beads 330 are disposed on the cord 140 between the retaining bead 145 and the decorative bead 150. Two other decorative beads 335 are disposed on the cord between the retaining bead 145 and the decorative bead 160.

Alternative embodiments are possible. For instance, any of the variations discussed above with reference to FIG. 1 are also possible with respect to the embodiment illustrated in FIG. 3.

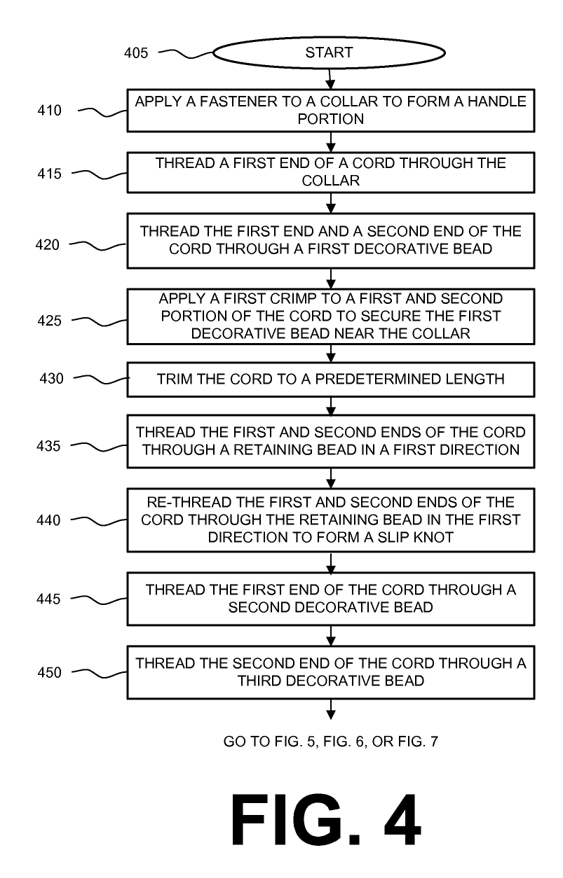

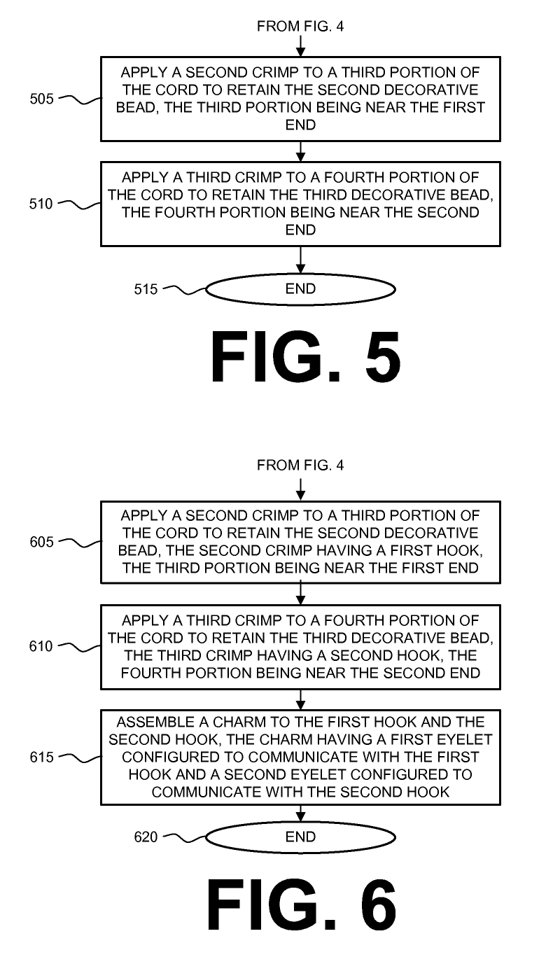

FIG. 4 is a flow diagram of a manufacturing method, according to an embodiment of the invention. After starting in step 405, the process applies a fastener 115 to a collar 105 to form a handle portion 110 in step 410. Then, in step 415, the process threads a first end of a cord 140 through the collar 105. Next, in step 420, the process threads the first end and a second end of the cord 140 through a first decorative bead 120. The process applies a first crimp 125 to a first and second portion of the cord 140 to secure the first decorative bead 120 near the collar 105 in step 425. In step 430, the process trims the cord 140 to a predetermined length. The process threads the first and second ends of the cord 140 through a retaining bead 145 in a first direction in step 435, and re-threads the first and second ends of the cord 140 through the retaining bead 145 in the first direction to form a slip knot in step 440. The process threads the first end of the cord 140 through a decorative bead 150 in step 445 and threads the second end of the cord 140 through a third decorative bead 160 in step 450.

Variations to the process illustrated in FIG. 4 and described above are possible. For instance, step 410 could be omitted in the case of a rigid collar, or where a handle is not desired. In addition, one or more of steps 420, 445 and/or 450 can be eliminated to omit one or more decorative beads, according to design choice. Alternatively, one or more steps could also be added to include one or more additional decorative beads. Step 425 could be omitted, although such step may be preferable when step 420 is performed so that the first decorative bead does not interfere with operation of the slip knot. Step 430 could be eliminated or performed at a different point in the sequence of steps illustrated in FIG. 4.

The process illustrated in FIG. 4 and described above can be used for manufacturing a portion of the apparatuses illustrated in FIGS. 1-3.

FIG. 5 is a flow diagram of a manufacturing method, according to an embodiment of the invention. The process illustrated in FIG. 5 can be used to complete the manufacture of the apparatus illustrated in FIG. 1. In step 505, the process applies a second crimp 155 to a third portion of the cord 140 to retain the second decorative bead 150, the third portion being near the first end. Then, in step 510, the process applies a third crimp 165 to a fourth portion of the cord 140 to retain the third decorative bead 160, the fourth portion being near the second end. The process terminates in step 515.

FIG. 6 is a flow diagram of a manufacturing method, according to an embodiment of the invention. The process illustrated in FIG. 6 can be used to complete the manufacture of the apparatus illustrated in FIG. 2. In step 605, the process applies a second crimp 205 to a third portion of the cord 140 to retain the second decorative bead 150. The second crimp 205 has a first hook 210. The third portion of the cord 140 is near the first end of the cord 140. In step 610, the process applies a third crimp 215 to a fourth portion of the cord 140 to retain the third decorative bead 160. The third crimp 215 has a second hook 220. The fourth portion of the cord 140 is near the second end of the cord 140. In step 615, the process assembles a charm 225 to the first hook 210 and the second hook 220. The charm 225 has a first eyelet 230 configured to communicate with the first hook 210, and a second eyelet 235 configured to communicate with the second hook 220. The process terminates in step 620.

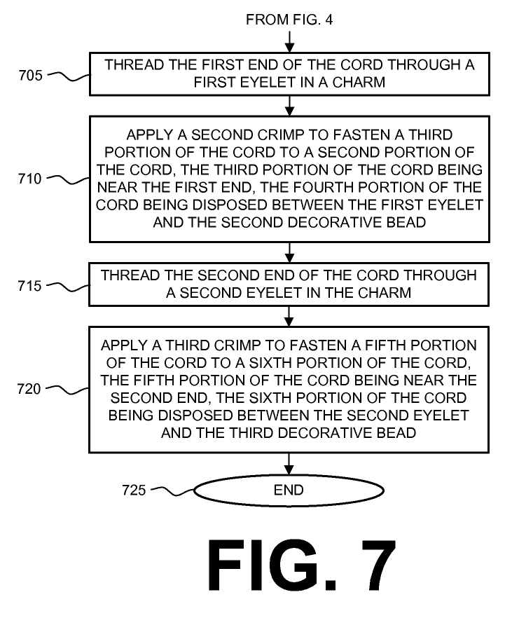

FIG. 7 is a flow diagram of a manufacturing method, according to an embodiment of the invention. The process illustrated in FIG. 7 can be used to complete the manufacture of the apparatus illustrated in FIG. 3. In step 705, the process threads the first end of the cord 140 through a first eyelet 310 in a charm 305. In step 710, the process applies a second crimp 320 to fasten a third portion of the cord 140 to a second portion of the cord 140. The third portion of the cord 140 is near the first end of the cord 140; the fourth portion of the cord 140 is disposed between the first eyelet 310 and the second decorative bead 150. In step 715, the process threads the second end of the cord 140 through a second eyelet 315 in the charm 305. Then, in step 720, the process applies a third crimp 325 to fasten a fifth portion of the cord 140 to a sixth portion of the cord 140. The fifth portion of the cord 140 is near the second end of the cord 140; the sixth portion of the cord 140 is disposed between the second eyelet 315 and the third decorative bead 160. The process terminates in step 725.

To manufacture the apparatus illustrated in FIG. 3, step 445 could include threading the first end of the cord 140 through decorative beads 330, and step 450 could include threading the second end of the cord 140 through decorative beads 335.

Embodiments of the invention thus provide an apparatus to secure the cork 130 or other stopper between portions of the cord 140 that are disposed between the crimp 125 and the slip knot formed by the cord 140 and the retaining bead 145. Other embodiments of the invention provide a method for manufacturing the apparatus. In embodiments of the invention, the collar 105 may absorb drips that that may be created when a person pours wine or other liquid from the bottle 135. The beads 120, 150, 160, 330, and/or 335 may be used to decorate the apparatus. Likewise, the charms 225 or 305 may decorate the apparatus.

It will be apparent to those skilled in the art that modifications and variations can be made without deviating from the spirit or scope of the invention. For example, alternative features described herein could be combined in ways not explicitly illustrated or disclosed. Moreover, although the illustrated embodiments were described with reference to a wine bottle, the invention is applicable to water bottles or other containers. Thus, it is intended that the present invention cover any such modifications and variations of this invention provided they come within the scope of the appended claims and their equivalents.

I claim:

1. An apparatus configured to hold a bottle stopper, the apparatus comprising:
a collar configured to communicate with a neck of a bottle;
a cord coupled to the collar, a first end and a second end of the cord extending from the collar, the cord having a slip knot, the apparatus configured to secure the bottle stopper between the slip knot and the collar.

2. The apparatus of claim 1, wherein the collar includes and elastic band.

3. The apparatus of claim 1, wherein the collar is liquid absorbent.

4. The apparatus of claim 1, wherein the collar includes a handle.

5. The apparatus of claim 4, wherein the collar includes a fastener coupling a first portion of the collar to a second portion of the collar.

6. The apparatus of claim 5 wherein the fastener is a rivet.

7. The apparatus of claim 1, further comprising a crimp disposed on the cord between the slip knot and the collar.

8. The apparatus of claim 7, further comprising a decorative bead disposed between the crimp and the collar, a portion of the cord being threaded through the decorative bead.

9. The apparatus of claim 1, wherein the slip knot includes a retaining bead.

10. The apparatus of claim 1, further comprising:
a first crimp coupled to the first end of the cord; and
a second crimp coupled to the second end of the cord, the slip knot being disposed on the cord between the first crimp and the collar, the slip knot further being disposed on the cord between the second crimp and the collar.

11. The apparatus of claim 10, further comprising:
a first decorative bead disposed between the first crimp and the slip knot, a first portion of the cord being threaded through the first decorative bead; and
a second decorative bead disposed between the second crimp and the slip knot, a second portion of the cord being threaded through the second decorative bead.

12. The apparatus of claim 10, further comprising a charm coupled to the first crimp and the second crimp.

13. A method for manufacturing a holder for a bottle stopper, the method comprising:
threading a first end of a cord through a collar;
threading the first end and a second end of the cord through a retaining bead; and
re-threading the first end and the second end of the cord through the retaining bead to form a slip knot, the apparatus configured to hold the bottle stopper between the slip knot and the collar.

14. The method of claim 13, further comprising:
before threading the first end and the second end of the cord through the retaining bead, threading the first end and the second end of the cord through a first decorative bead; and
applying a first crimp to a first and second portion of the cord to secure the first decorative bead near the collar, the apparatus configured to hold the bottle stopper between the slip knot and the first crimp.

15. The method of claim 13, further comprising:
applying a first crimp to the first end of the cord; and
applying a second crimp to a second end of the cord.

16. The method of claim 15, further comprising:
before applying the first crimp, threading the first end of the cord through a first decorative bead; and
before applying the second crimp, threading the second end of the cord through a second decorative bead.

17. The method of claim 15, further comprising coupling a charm to the first crimp and the second crimp, the charm including a first eyelet and a second eyelet, the first crimp including a first hook, the second crimp including a second hook, the coupling including threading the first hook through the first eyelet, the coupling further including threading the second hook through the second eyelet.

18. The method of claim 15, further comprising:
before applying the first crimp, threading the first end of the cord through a first eyelet in a charm; and
before applying the second crimp, threading the second end of the cord through a second eyelet in the charm, applying the first crimp including applying the first crimp to a first portion of the cord, the first portion of the cord being disposed between the first eyelet and the slip knot, applying the second crimp including applying the second crimp to a second portion of the cord, the second portion of the cord being disposed between the second eyelet and the slip knot.
